(19) United States
(12) Patent Application Publication
(10) Pub. No.: US 2025/0111341 A1
(43) Pub. Date: Apr. 3, 2025

(54) SYSTEM AND GRAPHICAL USER INTERFACE FOR GENERATING AND MANAGING TASK ITEMS

(71) Applicant: Atlassian Pty Ltd., Sydney (AU)

(72) Inventors: Hernan Camilo Gomez Rodriguez, Sydney (AU); Jitendra Kumar Chaudhary, Bengaluru (IN); Sahil Seth, Bengaluru (IN); Lee Standen, San Francisco, CA (US)

(21) Appl. No.: 18/375,160

(22) Filed: Sep. 29, 2023

(51) Int. Cl. G06Q 10/1093

(52) U.S. Cl. CPC G06Q 10/1097

(57) ABSTRACT

A method may include receiving a plurality of event records from an event service, each respective event record associated with a user and originating at an event source, and determining whether an event record of the plurality of event records corresponds to a task for the user. The method may further include generating a task item for the task. The method may further include, identifying a task category for the task item, determining a task category rank for the task item, allocating the task item to a user-specified task-category block of a set of user-specified task-category blocks associated with the selected task category, the allocation based at least in part on the task category rank of the task item, and displaying a representation of the task item in a task item object of a graphical user interface in accordance with the task category rank of the task item.

### TECHNICAL FIELD

The present disclosure is generally directed to generating and managing task items, and, more specifically, to systems and methods for generating task items from event records from disparate sources and clustering task items based on a character of the task items.

### BACKGROUND

Modern electronic devices facilitate a myriad of uses, both for business and personal endeavors. For example, electronic devices like personal computers, tablets, and mobile phones, are used in both business and personal contexts for creating and storing documents, writing computer code, communicating with other individuals (e.g., via email, chat services, voice and video calls, etc.), and the like. Electronic devices may also provide calendars and task management tools that facilitate the scheduling and management of appointments, meetings, tasks, and other events.

### SUMMARY

A method may include receiving a plurality of event records from an event service, each respective event record associated with a user and originating at an event source, and determining whether an event record of the plurality of event records corresponds to a task for the user. The method may further include, in accordance with a determination that the event record corresponds to a task for the user, extracting content from the event record, generating a task item for the task, the task item including the extracted content, and storing the task item in association with the user. The method may further include, analyzing at least one of the task item or the event record to identify, independent of the event source, a software application associated with the task, selecting, based at least in part on the identified software application, a task category for the task item, the task category selected from a set of candidate task categories, determining a task category rank for the task item, the task category rank defining a ranking of the task item relative to other task items in the selected task category, allocating the task item to a user-specified task-category block of a set of user-specified task-category blocks associated with the selected task category, the allocation based at least in part on the task category rank of the task item, and displaying a representation of the task item in a task item object of a graphical user interface in accordance with the task category rank of the task item.

The event record may be a first event record, the task may be a first task, the task item may be a first task item, the content may be first content, and the method may further include in accordance with a determination that a second event record corresponds to a second task that may be different than the first task, generating and storing a second task item for the second task, and in accordance with a determination that the second event record corresponds to the first task extracting second content from the second event record, generating a third task item for the first task, the third task item including the extracted second content, storing the third task item in association with the user, and causing a representation of the third task item to be displayed in the task item object in association with the first task item. The method may further include, in response to receiving an indication of completion of the first task item, removing the representations of the first task item and the second task item from the task item object.

The event record may be a first event record, the content may be first content, and the method may further include, in accordance with a determination that a second event record corresponds to a same task as the first event record extracting second content from the second event record, storing the extracted second content in the task item, and causing the extracted second content to be displayed in the task item object in the representation of the task item.

A plurality of task items may be associated with the selected task category, each respective task item in the plurality of task items associated with a respective task category rank, and the method may further include, in response to a user creating the user-specified task-category block for the selected task category in a calendar object of the graphical user interface, assigning respective task items of at least a subset of the plurality of task items to the user-specified task-category block, and displaying the assigned subset of the plurality of task items in the task item object in accordance with their respective task category ranks. The user-specified task-category block may be a first user-specified task-category block, the subset of the plurality of task items may be a first subset of the plurality of task items, and the method may further include, in response to a user creating a second user-specified task-category block for the selected task category in a calendar object of the graphical user interface, assigning respective task items of at least a second subset of the plurality of task items to the second user-specified task-category block, and displaying the assigned second subset of the plurality of task items in the task item object in accordance with their respective task category ranks.

The task may be a first task, the first task may correspond to a first operation for an issue of an issue tracking system, the event record may be a first event record, the task item may be a first task item, the task category may be a first task category, and the method may further include, in accordance with a determination that a second event record corresponds to a second operation for the same issue as the first task, the second operation different from the first operation, generating a second task item for the second operation, and selecting, based at least in part on the second operation, a second task category for the second task item, the second task category different from the first task category.

A method may include receiving a plurality of event records from an event service, each respective event record associated with a user and originating at an event source, and determining whether an event record of the plurality of event records corresponds to a task for the user. The method may further include, in accordance with a determination that the event record corresponds to a task for the user extracting content from the event record, generating a task item for the task, the task item including the extracted content, and storing the task item in association with the user. The method may further include providing the task item as input to a trained categorization model, the trained categorization model trained with training data generated from a set of respective sample task items each associated with a respective sample task category of a plurality of task categories, assigning the task item to a selected task category based on output from the trained categorization model, determining a task category rank for the task item, the task category rank defining a ranking of the task item relative to other task items in the selected task category, allocating the task item to a user-specified task-category block of a set of user-specified task-category blocks associated with the selected task category, the allocation based at least in part on the task category rank of the task item, and displaying a representation of the task item in a task item object of a graphical user interface in accordance with the task category rank of the task item.

The event record may be a first event record, the task may be a first task, the task item may be a first task item, and the method may further include generating and storing a second task item for a second task different from the first task, in response to an assignment input from the user, associating the second task item with a second task category, and retraining the trained categorization model using updated training data that includes the second task item associated with the second task category. The task may be performable, by the user, on a software application that is different from the event source. The software application may be an issue tracking system.

The event record may be a first event record, the task may be a first task, the task category may be a first task category, the task item may be a first task item, and the method may further include, in accordance with a determination that a second event record different from the first event record corresponds to a second task for the user, generating and storing a second task item for the second task, providing the second task item as input to the trained categorization model, and assigning the second task item to a second task category based on output from the trained categorization model, the second task category different from the first task category. The first event record and the second event may relate to different tasks for a same content item.

A plurality of task items may be associated with the selected task category, each respective task item in the plurality of task items associated with a respective task category rank, and the method may further include, in response to a user creating the user-specified task-category block for the selected task category in a calendar object of the graphical user interface, assigning respective task items of at least a subset of the plurality of task items to the user-specified task-category block, and displaying the assigned subset of the plurality of task items in accordance with their respective task category ranks.

The user-specified task-category block may include a user-defined start time and a user-defined duration. The user-specified task-category block may be a first user-specified task-category block and may include a first user-defined start time and a first user-defined duration, and the set of user-specified task-category blocks may include a second user-specified task-category block, the second user-specified task-category block including a second user-defined start time different from the first user-defined start time and a second user-defined duration different from the first user-defined duration.

A computer system may include at least one processor, and at least one memory storing instructions, which when executed by the at least one processor, cause the at least one processor to perform operations including receiving a plurality of event records from an event service, each respective event record associated with a user and originating at an event source, and determining whether an event record of the plurality of event records corresponds to a task for the user. The instructions may further include instructions that cause the at least one processor to perform operations including, in accordance with a determination that the event record corresponds to a task for the user extracting content from the event record, generating a task item for the task, the task item including the extracted content, and storing the task item in association with the user. The instructions may further include instructions that cause the at least one processor to perform operations including analyzing at least one of the task item or the event record to identify, independent of the event source, a software application associated with the task, selecting, based at least in part on the identified software application, a task category for the task item, the task category selected from a set of candidate task categories, determining a task category rank for the task item, the task category rank defining a ranking of the task item relative to other task items in the selected task category, allocating the task item to a user-specified task-category block of a set of user-specified task-category blocks associated with the selected task category, the allocation based at least in part on the task category rank of the task item, and displaying a representation of the task item in a task item object of a graphical user interface in accordance with the task category rank of the task item.

The task item may be a first task item, and the instructions may further include instructions that cause the at least one processor to perform operations including providing a second task item as input to a trained categorization model, the trained categorization model trained with training data generated from a set of respective sample task items each associated with a respective sample task category of a plurality of task categories, and assigning the second task item to a second selected task category based on output from the trained categorization model.

A plurality of task items may be associated with the selected task category, each respective task item in the plurality of task items associated with a respective task category rank, and the instructions may further include instructions that cause the at least one processor to perform operations including, in response to a user creating the user-specified task-category block for the selected task category in a calendar object of the graphical user interface, assigning respective task items of at least a subset of the plurality of task items to the user-specified task-category block, and displaying the assigned subset of the plurality of task items in the task item object in accordance with their respective task category ranks. The user-specified task-category block may be a first user-specified task-category block, the subset of the plurality of task items may be a first subset of the plurality of task items, and the instructions may further include instructions that cause the at least one processor to perform operations including, in response to a user creating a second user-specified task-category block for the selected task category in a calendar object of the graphical user interface, assigning respective task items of at least a second subset of the plurality of task items to the second user-specified task-category block, and displaying the assigned second subset of the plurality of task items in the task item object in accordance with their respective task category ranks.

### BRIEF DESCRIPTION OF THE DRAWINGS

In the drawings:

FIG. 1A depicts an example networked computer system in which various features of the present disclosure may be implemented.

FIG. 1B depicts an example task management service with task items generated from event records from event record sources.

FIGS. 2A-2D depict example graphical user interfaces associated with a task management service.

FIGS. 3A-3B depict example calendar user interfaces of a task management service.

FIG. 4 depicts an example task item view user interface of a task management service.

FIG. 5 depicts an example process for generating and managing task items.

FIG. 6 depicts an example electrical block diagram of an electronic device that may perform the operations described herein.

While the invention as claimed is amenable to various modifications and alternative forms, specific embodiments are shown by way of example in the drawings and are described in detail. It should be understood, however, that the drawings and detailed description are not intended to limit the invention to the particular form disclosed. The intention is to cover all modifications, equivalents, and alternatives falling within the scope of the present invention as defined by the appended claims.

### DETAILED DESCRIPTION OF THE EMBODIMENTS

In the following description numerous specific details are set forth in order to provide a thorough understanding of the claims. It will be apparent, however, that the claims may be practiced without these specific details. In some instances, well-known structures and devices are shown in block diagram form in order to avoid unnecessary obscuring.

The systems and techniques described herein are directed to systems and methods for automatically identifying tasks, for a user, from multiple disparate application services, and automatically organizing those tasks into task clusters or categories. In many work environments, a user may interact with myriad different application services that can be a source of tasks for the user. For example, the user may receive emails that specify a particular task that the user is to complete. The user may also receive direct assignments of tasks in a codebase or issue tracking system. The user may also receive a request from another person in a chat application. It may be cumbersome for the user to monitor all of the potential sources for tasks and to effectively manage each of those tasks. Accordingly, described herein are techniques that monitor events from multiple different application services (e.g., email applications, software development applications, chat applications, collaborative document systems, etc.), and identify events that correspond to or otherwise indicate a task for the user to perform.

Given the variety of tasks that an individual may be called upon to perform as part of their occupation or personal life, it may be helpful to group together tasks that pertain to a similar role, capacity, or function, rather than simply working on tasks in the order they are assigned or due. For example, an individual may be called on to perform tasks associated with distinct roles or capacities, such as a managerial or supervisory role, a human resources role, and a content production role (e.g., computer coding, document creation, etc.), or may be called on to perform tasks associated with different skill sets. In many cases, it may be more efficient for the individual to work on tasks related to a particular role, capacity, or skill set together, even if those tasks are from disparate sources or are accomplished using different software applications or services. Additionally, a task list that is ordered simply based on due dates or urgency may require a user to repeatedly change their focus and context, which may be inefficient and distracting, as compared to a task list that groups similar tasks together to reduce context switching. Thus, instead of simply populating a task list or schedule with identified tasks and ordering them based on due dates or urgency, the techniques described herein analyze the tasks that are identified from the various different sources, and determine which role, capacity, or skill set of an individual the task relates to. The tasks may then be grouped into task categories based on the identified roles, capacities, or skill sets, and automatically incorporated into the time blocks of a user's calendar that have been pre-assigned for those task categories. Accordingly, tasks are automatically grouped together and ordered in a manner that can reduce or minimize context and focus switching.

As used herein, a task category may reflect a property or character of a task that is indicative of the role or function of an individual in the performance of that task, or the skill set used by an individual in the performance of that task, or another common property of a set of tasks (e.g., whether they relate to a same project). Thus, for example, a task may be identified as relating to a particular operator role or function (e.g., managerial role, supervisory role, human resources role, hiring role, professional development role, etc.), and may be categorized accordingly. It will be understood that a task category does not necessarily correspond to any official role, occupation, capacity, or title of an individual, but instead relates to the character of the task itself. Thus, for example, an individual can have tasks that are classified as managerial or supervisory, even if the individual does not have an official title of manager or supervisor. Moreover, as described herein, task categories may be defined by a user, and may reflect any selected commonality between tasks. For example, a task category may be defined for tasks related to a particular project, document, codebase, issue, individual, etc.

In some cases, an official role, occupation, capacity, or title of an individual may determine how a particular task is classified for them. Thus, a same task may be classified differently for different individuals. For example, a task “approve expense report” may be identified as reflecting an operator role of “administrative role” when the task is assigned to the individual who originated the expense report, but may be identified as reflecting an operator role of “business development role” when the task is assigned to a supervisor who approves expense reports for an organization. Thus, a role (or other property) of an individual may be used to determine which task category a task will be assigned to for that individual.

A task management service as described herein may include predefined task categories and may also allow users to create user-defined task categories. Moreover, tasks may be assigned to task categories using categorization rules. Categorization rules may be defined in various ways. For example, a task management system may include predefined rules that assign tasks to task categories based on one or more properties of the task. Users may also create user-defined rules that assign tasks to task categories based on task properties. The task management system may also use machine learning techniques to create models that will assign tasks to task categories. The models may be trained using a set of sample task assignments, which may reflect actual historical task categorizations by users of the task management system. Thus, the techniques described herein may adapt the way it categorizes tasks for each individual user, based on that user's own preferences and task management actions.

As noted above, grouping tasks that are associated with similar operator roles may improve an individual's efficiency in completing their tasks. Accordingly, the techniques described herein allow users to predefine dedicated time blocks (referred to herein as user-specified task-category blocks) in a calendar for selected task categories. Once tasks are identified and assigned to a task category, the task management service may allocate the tasks to the dedicated time blocks, and order the tasks, within the time block, according to a task ranking. Thus, the task management system prioritizes a user's tasks, while also conforming to the user's predefined time allocation for particular categories of tasks.

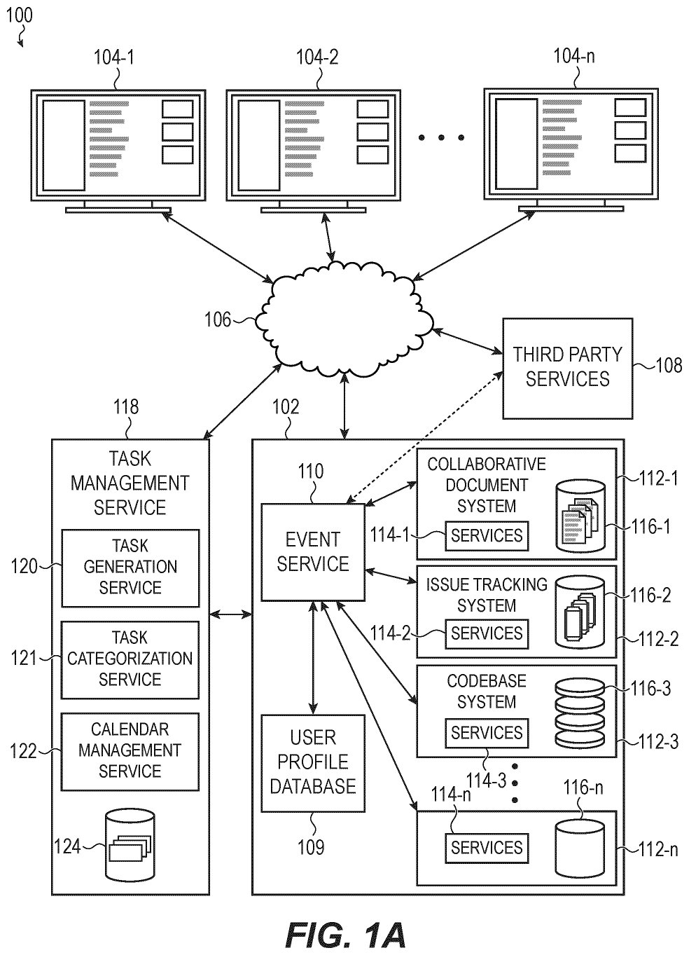

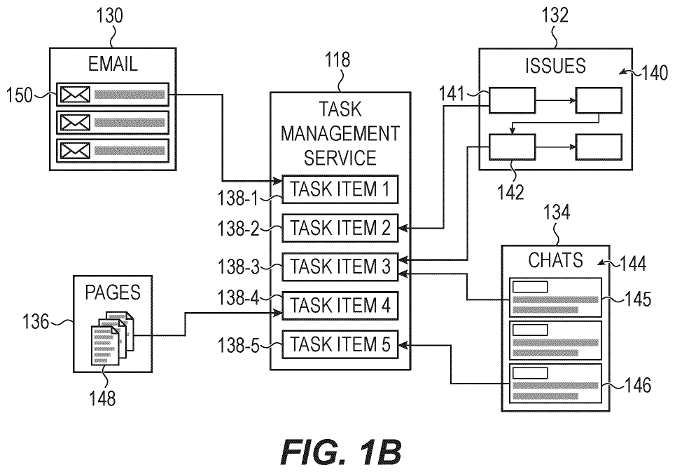

FIG. 1A depicts an example networked computer system 100 (or simply “system 100”) in which the techniques described herein may be employed. The system 100 includes an application platform 102, third party services 108, a task management service 118, and client devices 104 (104-1, . . . , 104-n) that communicate via a network 106 (e.g., the Internet). The client devices 104 may be any suitable type of device, including but not limited to a desktop or laptop computer, tablet computer, mobile phone, personal digital assistant, smart device, voice-based digital assistant, or the like. While FIG. 1A illustrates certain example communications or connections between various components, these examples are not intended to represent the only communications or connections between the components, and other communications or connections between the various components may be effectuated, such as via the network 106.

The application platform 102, also referred to herein as hosted services or host servers, may be or may include one or more servers, content stores (e.g., databases), communications systems, data structures, programs, or other components, systems, or subsystems that provide services described herein. The application platform 102 may also be referred to herein as hosted services, which may be provided by one or more host servers or other hardware elements of the system 100. The application platform 102 may include an event service 110, one or more software applications 112 (e.g., 112-1, . . . , 112-n), and a user profile database 109. The one or more software applications 112 provide content and content services to users of the system 100, as described herein.

The event service 110 may generate event logs for users of the application platform 102 based on events that occur, within the application platform 102 or elsewhere, with respect to the users. Events may correspond to any action that occurs within the system, including, without limitation, creating content items, editing content items, commenting on content items, changing a state of a content item, requesting approval on a change to a content item, assigning a task, generating a chat message, sending an email, and the like. The event service 110 may monitor activity of the software applications 112 (or otherwise receive data about activities of the software applications or third-party services 108), and generate event records (e.g., in event logs) based on the activity. Events may relate to one or more users, and individual event logs may be created for individual users. For example, when a content item is edited by a user, the activity may be detected by the event service 110, and an event record may be logged for the user (indicating that the user edited the content item). Additionally, in response to the editing, event records may be logged for other users based on their relationship to the content item and/or the user. Thus, an event record may be logged for the user's supervisor (e.g., indicating that the user edited a content item), an event may be logged for the author of the content item (e.g., indicating that the content item was edited), and an event may be logged for subscribers or followers of the content item (e.g., indicating that the content item was edited). Event records from the event service 110 may be used to identify tasks for a user. For example, as described herein, an event record indicating that a project (e.g., an issue ticket, code request, etc.) has been assigned to a user may be used, by the task management service 118, to generate a task item for the user.

The software applications 112 may include application services 114 (e.g., 114-1, . . . , 114-n) and data stores 116 (e.g., 116-1, . . . , 116-n). Application services 114 may facilitate the creation, deletion, management, editing, serving, and/or other services related to the content and/or content items associated with that software application and stored in the data store 116. Data stores 116 may be databases or other data storage resources that store content items and/or other data related to a software application 112.

In some cases, a first software application 112-1 may be a collaborative document system or platform, which may also be referred to as a content collaboration system or platform. The collaborative document system may allow users (e.g., via clients 104) to create, modify, view, and/or otherwise interact with system content. User-generated content (e.g., content created by or designated by system users) is generally organized in what is referred to herein as a document space or simply a space. Generally, a document space includes a set of documents (or pages) having a hierarchical relationship to each other as designated by a document tree (or page tree) and also a set of blog entries (or other entries) having a hierarchical relationship to each other as designated by a blog tree. Document spaces generally include other content including a calendar, a space home page or overview, a space calendar, and other space-specific content. Document spaces may also include in-line comments, comment sections for each document or page, and other content that is adapted to receive and collect user feedback. Further, each document space designates at least one space administrator, which identifies a user account on the system having administrator authority and permissions. Specifically, a user account designated as a space administrator is granted the permission to set permissions for space-specific content including the set of documents (or pages), the set of blog entries, calendar entries, space overview, and other space content with respect to other system users. While there may be more than one space administrator, the authority to set permissions for a given space is generally not exceeded by another system user other than a tenant-level administrator or other special user account. In many cases, the space administrator is the creator or author of the document space.

The space content including electronic documents, electronic pages, blog posts, calendar entries and other content may be stored in the data store 116-1. User-generated content may include content such as text, images, graphics, tables, or the like. Documents may be linked or otherwise related to one another in a document hierarchy as designated by a hierarchical element tree (e.g., a document tree or a page tree). Documents (e.g., user-generated documents) may be stored in the data store 116-1 as discrete files, data structures, or other digital objects. The data store 116-1 may be a centralized or single physical data storage medium or, alternatively, may be distributed across physical memory managed by multiple devices.

The application services 114-1 of the collaborative document system may facilitate content services related to the documents, including causing user interfaces of the collaborative document system to be displayed to a user on a client 104, receiving user inputs relating to the creation and/or modification of documents, and the like. The application services 114-1 may also send to the event service 110 notifications of events relating to user-generated documents stored in the data store 116-1.

A second software application 112-2 may be an issue tracking system that tracks issues via issue tickets, which may be stored in the data store 116-2. Issue tickets may include content, such as a user-generated description of an issue, issue status (e.g., closed, open, awaiting review), user assignments, issue ticket urgency, issue ticket age, and the like. In some cases, issue tickets may include user-generated specifications of issues in computer code of software products.

Issue tickets may be stored in the data store 116-2 as files, data structures, or the like. The application services 114-2 of the issue tracking system may facilitate content services related to the issue tickets, including causing user interfaces of the issue tracking system to be displayed to a user on a client 104, receiving user inputs relating to the creation and/or modification of issue tickets (e.g., changing status, receiving content related to the issue and/or issue resolution, etc.), changes to issue status, changes to user assignments, and the like. The application services 114-2 may also send to the event service 110 notifications of events relating to the issue tickets stored in the data store 116-2.

A third software application 112-3 may be a codebase system that provides services related to creating, developing, maintaining, and/or deploying software code. The third software application may include, for example, a source code management system (SCM system), deployment management system, or other system configured to manage the storage, revision, and/or deployment of software products. Software code and other data associated with the third software application 112-3 may be stored in codebases 116-3. In some cases, code for distinct software programs, environments, platforms, or the like, may be stored in or as distinct codebases 116-3. Distinct codebases may be stored in different databases or data stores, or they may share one or more databases or data stores. The application services 114-3 may also send to the event service 110 notifications of events relating to the issue tickets stored in the data store 116-2.

Other software applications 112-n may also provide services in the application platform 102, and send, to the event service 110, notifications of events relating to the software applications 112-n and/or content related to the software applications 112-n. Examples of other software applications 112-n include, without limitation, email systems, messaging systems, source code management systems, whiteboarding applications, user interface design applications, and project management systems, and any other suitable application, service, or system from which tasks may be identified.

The application platform 102 may include one or more authorization services or authorization servers that are used to authenticate system users (accessing the system through client devices 104. Once authenticated, the users may be granted access to one or more of the respective software applications, platforms, and system content in accordance with a permissions scheme or profile stored with respect to each registered user account, which may be stored by or managed by the user profile database 109. Each application may have a discrete or separate authorization service or system, or applications may share or leverage a common authorization service or server. In one example, the application platform 102 provides a unified authentication service by verifying access from a permitted user and pairing the verified user with a corresponding user account in one or more of the software platforms. As one non-limiting example, the authorization service or server may use a shared cookie/scheme to authenticate each user account on each software application or platform. As another non-limiting example, the authorization service or server may authenticate users with a single sign-on service (SSO) and/or a two-factor authentication (2FA) service.

One or more third party services 108 may also interface with the event service 110 to provide notifications of events for inclusion into event logs. For example, as described herein, third party services 108 may send to the event service 110, via an application programming interface, a notification of an event, and content associated with the event. The event service 110 may incorporate the content into an event log for an associated user. Example third party services 108 include, without limitation, email systems, messaging systems, project management systems, collaborative document systems, codebase systems, issue tracking systems, source code management systems, whiteboarding systems, user interface design systems, and any other suitable application, service, or system from which tasks may be identified. Third party services 108 may also interface with the task management service 118 (e.g., instead of or in addition to interfacing with the event service 110) to provide notifications of events for the identification of tasks and the generation of task items. For example, as described herein, third party services 108 may send to the task management service 118, via an application programming interface (and via network 106), notifications of events and content associated with the events (e.g., event records). The third party services 108 may provide event records that have a same format as those stored by the event service 110, or they may have a different format. The task management service 118 may analyze the information received from the third party services 108 and generate task items, as described herein. Information from the third party services 108 may be provided to the task management service 118 according to a push protocol in which the third party services 108 send the notifications information according to their own schedule (e.g., in response to the occurrence of events), or according to a fetch protocol in which the task management service 118 requests information from the third party services 108.

The event service 110 communicates with the software applications 112 and/or third-party service(s) 108 to receive notifications of events (and optionally content associated with the events). The notifications of events may be provided to the event service 110 according to a push protocol in which the software applications 112 send the notifications according to their own schedule (e.g., in response to an event occurring and generating a notification), or according to a fetch protocol in which the event service 110 requests notifications of events from the software applications.

The event service 110 may generate event records and event logs for users based on the received notifications, and send and/or provide the event logs or event records to the task management service 118. For example, the event service 110 may receive a notification that a document in a collaborative document service (e.g., the software application 112-1) has been modified, and generate an event record based on the notification. The event record may include information about the document, a portion of the document's content, information about the modification, an identity of the user who modified the document. The event record may be provided to or otherwise accessed by the task management service 118, which determines whether the event record corresponds to or suggests a task for a user. In accordance with a determination that the event record corresponds to or suggests a task for a given user, the task management service 118 generates a task item for that user, as described herein. In accordance with a determination that the event record does not correspond or suggest a task, the task management service 118 may take no action with respect to the event record.

Event records may include various information items related to the event. For example, the event record may include identifiers of users who are associated with the event or the underlying content item to which the event relates, identifiers of a software application, service, or system on which the event occurred, text or other content associated with the event (e.g., text of a chat or text that was included in a document modification), text or other content associated with the underlying content item(s), identifiers or titles of the underlying content item(s), statuses of the underlying content item(s) (e.g., a status of an issue to which the record relates), or the like. Users who are associated with the event or the underlying content item to which the event relates may include users who initiated the event (e.g., an identifier of a user who modified a document or assigned a task or sent a message), users who are identified in the event or underlying content item (e.g., a user who is mentioned in a comment or modification to a content item, a user to whom an issue or other content item is assigned), users who are associated with an underlying content item (e.g., an author of a content item to which the event relates, a viewer of or subscriber to the underlying content item). In general, any data or information about the event, the software application on which the event occurred, the content item to which the event relates, and the users associated with event and/or content item may be captured in the event record.

The user profile database 109 may store and maintain user profiles about users of the system 100. User profiles may include numerous types of information about the users of the system, including but not limited to names, departments, job titles, roles, content with which they are associated (e.g., documents, issue tickets, messages, etc.), team and/or project associations, relative position in a hierarchy in an organization or entity, or the like. The event service 110 may use the information in the user-profile database to determine what events should be included in a user's event log.

The task management service 118 may provide services related to creating and managing task items for users, including identifying tasks from event records for users, generating task items, categorizing task items, and scheduling task items on a user's calendar. The task management service 118 may include a task generation service 120, a task categorization service 121, and a calendar management service 122. As shown in FIG. 1A, the task management service is separate from the application platform 102, though in some cases it may be part of the application platform 102.

The task generation service 120 may generate task items for users. In particular, the task generation service 120 may receive or otherwise access event records from the event service 110 and/or event records (or other information) from third party services 108 (which may not have been provided to the event service 110) and analyze the event records to determine whether a given event record corresponds to a task for a user. In order to determine whether an event record corresponds to a task, the task generation service 120 may analyze the event records to identify content that indicates or suggests a task. In some cases, the task generation service 120 may analyze the event records to identify words, terms, or phrases that indicate that the event corresponds to a task or should be addressed by a user. The task generation service 120 may use natural language processing models to determine whether a text component of an event record corresponds to a task. Thus, for example, an event record from a chat message that includes the language “can you please” may be identified as an event record that relates to a task.

In some cases, the task generation service 120 may identify certain predefined actions that are represented in an event record and that are indicative of a task. Predefined actions may include certain operations that can be performed in a software application. For example, if an issue, task, project, request, or the like is assigned to a user in a software application (e.g., via an assignment operation in a corresponding software application), the event record may include an indication that the event relates to an assignment. The task generation service 120 may identify the assignment action in the event record and may therefore determine that the event record corresponds to a task and generate a task item from that event record.

As another example, the task generation service 120 may include or apply rules that correlate certain types of event records to tasks. For example, any changes to a codebase may represent a task for a manager of that codebase (e.g., so that the manager can review the changes). As another example, modifications to a content item may represent a task for an administrator of that content item (e.g., so that the administrator can review the modifications). The task generation service 120 may determine that event records for a given type of event correspond to a task, and generate a task item from that event record.

The task generation service 120 may use machine learning techniques to create models that will identify whether a given event record corresponds to a task for a user. The models may be trained using a set of sample event records (which may reflect actual historical event records of the application platform 102), where the sample event records are tagged as corresponding to a task or not corresponding to a task. Thus, an event record may be provided to the models as an input, and the models may provide, as output, a likelihood that the event record does or does not correspond to a task. If the likelihood satisfies a condition (e.g., a threshold confidence value), the task generation service 120 may create a task item from the event record.

The task management service 118 may allow users to create or modify the rules or other processes that define which event records correspond to a task for that particular user. For example, one user may want task items to be generated each time a comment is added to a content item created by that user, while another user may not want such events to result in a task item being generated. Accordingly, the task management service 118 may store user-specific rule sets or task identification engines to determine which event records correspond to a task for particular users.

Once the task generation service 120 determines that an event record corresponds to a task for a particular user, the task generation service 120 may generate a task item and store the task item in association with the particular user. The task generation service 120 may extract content from the event record for inclusion in the task item. The content extracted from the event record and included in the task item may include, without limitation, an event source, a software application associated with the task, identifiers of users who are associated with the event record, an identifier of a content item to which the event record relates (e.g., a document, page, blog, issue, codebase, etc.), an identifier of a project to which the event record relates, a due date, an assignment date, content (e.g., text, images, etc.) from a content item to which the event record relates, message content (e.g., text) from a message to which the event record relates, etc.

In some cases, task items generated by the task generation service 120 may include at least an event source, a software application associated with the task, and an identifier of a user to whom the task relates. The event source refers to the software application or service on which the event originated (e.g., a chat service, an email service, a content collaboration system, an issue tracking system, etc.). The software application associated with the task refers to the software application on which the task may be performed, and may be the same as or different than the event source. For example, an email message from an email service (e.g., the event source) may refer to a task that is to be performed in an issue tracking system (e.g., the software application on which the task is performed). As another example, an event from an issue tracking system (e.g., assigning an issue to a user) may refer to a task that is to be performed in the issue tracking system. Task items may include other information, including, without limitation an identifier of a content item to which the event record relates (e.g., a document, page, blog, issue, codebase, etc.), an identifier of a project to which the event record relates, a due date, an assignment date, content (e.g., text, images, etc.) from a content item to which the event record relates, message content (e.g., text) from a message to which the event record relates, etc. The information in a task item may be extracted from the event record for which the task item was generated.

The identifier of the user to whom the task relates (which may be included in the task and may define the recipient of the task) may be a name or username of the individual who is to complete the task. The task generation service 120 may determine the user to whom the task relates by analyzing the event record, as described above. For example, the task generation service 120 may analyze the event record using natural language processing to determine an identity of a user who is the subject of a request or assignment. As another example, the task generation service 120 may identify a user to whom a task is assigned (e.g., when an issue or project is assigned to a user in a software platform). As yet another example, the task generation service 120 may identify the author, manager, or administrator of a content item to which the event record relates. The identified user may then be included in the task as the recipient or subject of the task.

Once tasks are identified from the event records and corresponding task items are generated, the task management service 118 may determine task categories for the task items using the task categorization service 121. As described above, the task categories reflect properties or characters of tasks that are indicative of the role or function of an individual in the performance of those tasks. Thus, tasks that relate to particular role or function of a user may be automatically scheduled together (e.g., sequentially, in a time block that is dedicated to that task category) so that the tasks may be addressed efficiently by the user.

The task categorization service 121 may categorize tasks into task categories of a set of candidate task categories. The task categorization service 121 may include a set of default task categories and may also provide users the option of creating new task categories (and optionally removing default task categories).

The task categorization service 121 may categorize tasks using various techniques. In some cases, the task categorization service 121 analyzes at least one of the task items or the event record (from which the task item was generated) to identify a software application on which the task is to be performed. Notably, this determination may be made independent of the event source. For example, as described above, a task may be identified in an event record from one source (e.g., an email application), but relate to a task that is performed in a different application (e.g., an issue tracking system). Thus, the task categorization service 121 can determine, based on the content of the event record, rather than on the source of the event record, a software application or other service on which the task is to be performed, even if that is different from the source of the information that initiated the task. As used herein, the software application or service on which the task is to be performed may be referred to as a target application.

The task categorization service 121 may then select, based at least in part on the identified software application (e.g., the target software application), a task category for the task item. Selecting a task category based, at least in part, on the target software application may result in tasks being categorized by the user role or function to which they relate. Thus, for example, task items that have a target application of a codebase system may relate to software development projects, and as such, may relate to the same user role or function. Accordingly, these task items may be categorized in the same task category.

Any other information that is included in the task item or the originating event record (or the underlying content items) may also be used to determine a task category. For example, a project to which a task item relates may be used to determine the task category (e.g., task items for a common project may be assigned to the same category). As another example, a state of an issue in an issue tracking system may be used to determine the task category (e.g., issues having a certain state or status may be assigned to the same category, which may be different from issues having a different state or status).

In some cases, trained categorization models may be used to classify or categorize task items. For example, a categorization model may be trained, using machine learning techniques, with training data that is generated from a set of sample task items each associated with a sample task category. The training data may include actual historical task categorizations by users of the task management system, and/or sample task categorizations that are generated for the purpose of training the task categorization model.

The task categorization model may be occasionally re-trained using updated training data. The updated training data may include user-selected task categories for particular task items. More particularly, as described herein, the task management service 118 may allow users to manually categorize certain task items. For example, if the task categorization service 121 is unable to categorize a task item (e.g., because the service is unable to identify a categorization for that item that satisfies a confidence condition), the user may be prompted to manually assign the task item to a task category. As another example, a user may change a categorization of a task item that was previously categorized. As yet another example, the task management service 118 may occasionally prompt the user to assign a task item to a task category. Such user-specified assignments of tasks to task categories may be incorporated into updated training data and used to train or re-train the task categorization model of the task categorization service 121. As noted above, the task categorization models may be updated in this manner for each individual user. Thus, the task categorization service 121 may adapt the way it categorizes tasks for each user based on that user's own preferences and task management actions. In such cases, different task categorization models may be stored for different users.

The task management service 118 also includes a calendar management service 122. The calendar management service 122 may determine how the categorized tasks associated with a user are populated into user-specified time blocks. More particularly, the task management service 118 may provide a calendar user interface in which users can create appointments, meetings, and other events. The calendar user interface also allows users to specify time blocks that are dedicated to or associated with the predefined task categories for that user. For example, a user can select a first time block each day (e.g., from 9 AM to 10 AM) for “supervisory tasks” (which may correspond to a first task category), and a second time block each day (e.g., from 2 PM to 5 PM) for “software development tasks” (which may correspond to a second task category). The start times and durations of the time blocks may be freely selected by the user and need not repeat each day or be at the same time each day, though the calendar management service 122 may provide users with options to define a repeating pattern or schedule of time blocks.

The calendar management service 122 may dynamically incorporate task items of a given task category in the time block(s) that correspond to the given task category. In particular, the calendar management service 122 may dynamically reassign task items among upcoming time blocks based on the availability of upcoming time blocks. Thus, for example, if a user changes the time blocks for a given task category (e.g., adding, deleting, or modifying time blocks), the calendar management service 122 may dynamically reassign the task items for that task category among the available time blocks.

The calendar management service 122 may organize the task items in a given time block based at least in part on task category ranks for the task items. In particular, the calendar management service 122 (or another service of the task management service 118) may determine task category ranks for each task item of a given task category. The task category ranks may be determined based on properties of the task item, the event record that corresponds to the task item, a content item to which the task item relates, or the like. Such properties may include a due date for the task, a start date for the task, an urgency of the task (e.g., as specified by the user or specified in the content item to which the event record and task item relate), an expected duration for the task (as specified by the user or determined based on historical data for the user for similar tasks), and the like. The task category ranks may define the order in which task items are displayed in the time blocks for a given task category. For example, task items having higher task category ranks (e.g., greater urgency, closer due dates, etc.) may be displayed higher in the list of task items.

Within a given time block for a given task category, the all of the user's task items may be listed or available to view and interact with, such that the user can easily see all of their tasks in that time block. For example, all task items in a given task category may be assigned to a time block (ranked according to their task category rankings). When a time block is viewed in a calendar user interface, the task items for that category may be displayed in the time block in accordance with their task category rankings.

In some cases, a user may choose not to have all of their task items displayed in every time block. For example, task items may be associated with an expected duration, and may be scheduled, in a time block, according to their duration. Thus, for example, if a time block is two hours, and the top two task items in that task category have durations of one hour, then the time block may schedule the first hour for the first task item, and the second hour for the second task item. In some cases, the calendar user interface limits the display of task items in a time block to a certain number of task items (e.g., each time block may display a maximum of five task items, with lower-ranked task items being assigned to later time blocks). The limit on displayable task items in a time block may correspond to the duration of the time block. For example, task items may be associated with a default duration of 15 minutes, and thus a time block of one hour may limit the number of tasks that are shown for that time block to 3 task items (with more task items being shown for longer duration time blocks).

The calendar management service 122 may also manage the completion status of task items. Thus, when a user indicates that a task is complete (e.g., an indication of task completion is received or detected), the calendar management service 122 may remove the task from the user's calendar (e.g., it may remove a representation of the completed task item from a time block in which it was displayed and generally cease displaying the task item in the calendar user interface).

The task management service 118 as described herein is able to create task items from multiple disparate sources and for multiple different target applications. FIG. 1B is a graphical example of how the task management service 118 may interact with multiple different sources to identify and generate task items, while also identifying events that would result in duplicative or redundant task items. For example, the task management service 118 is shown in FIG. 1B with task items 138-1-138-5. (The task items 138 may be associated with the same task category or different task categories.) The first task item 138-1 may have been generated from an event record associated with an email 150 from an email service 130. For example, the email 150 may have included a request that the user perform a task (e.g., “please complete this report”), and the task management service 118 generated the first task item 138-1 based on the event record for the email 150.

As noted above, in some cases, the same content item in an application platform may be associated with different tasks, which may also be associated with different task categories. For example, as shown in FIG. 1B, an issue 140 in an issue tracking system 132 may have multiple states or stages (e.g., lifecycle or work states or stages, such as issue intake, issue assignment, issue completion, and issue review), and the states may correspond to different tasks, and the task may correspond to different task categories (though in some cases, they may correspond to the same task category). Accordingly, the task management service 118 may generate a second task item 138-2 based on a first state 141 of an issue 140, and a third task item 138-3 based on a second state 142 of the issue 140. Further, the task items 138-2, 138-3 may be categorized in different task categories, as described herein, because of the different character of the tasks (e.g., one may be associated with administrative role or function, while another may be associated with a software development role).

The task management service 118 may also combine event records or otherwise generate or maintain only a single task item with respect to multiple event records, when those event records correspond to a same task. For example, as shown in FIG. 1B, both the state 142 of the issue 140 and the chat item 145 of a chat service 134 may relate to the same task. Accordingly, the task management service 118 may generate the third task item 138-3 with respect to both event records (rather than creating a different task for each event record). In order to avoid creating multiple task items for a single task, the task management service 118 may analyze event records to identify a task indicated by the event record and search existing task items for task items that match or refer to the same identified task. If another task item is found that refers to the same task (e.g., the same action item in a same content item), the task management service 118 does not generate another task item (and may associate the additional event record(s) with the already-existing task item).

FIG. 1B also illustrates a separate task item 138-4 having been generated with respect to a document or page 148 in a collaborative document system or platform 136, and a separate task item 138-5 having been generated from a chat event 146 in the chat service 134. Each of these task items may be associated with a different task. Moreover, as described above, each of the different task items shown in FIG. 1B may be uniquely assigned to a task category.

Because the task management service 118 creates task items based on the task that is to be performed (independent of the source of the event record), and because the task management service 118 categorizes tasks based on the character of the task (e.g., reflecting the role or function of an individual in the performance of those tasks, rather than the source of the event record that triggered the task item), task items may be grouped and presented to a user in a highly flexible and useful manner. As a result, the task categories may include task items from different sources (e.g., different software applications or services), tasks that are performed on different applications or services, task items that relate to multiple different event records, and the like.

As described herein, task items may be completed or performed via a graphical user interface associated with the task management service 118. In such cases, the task management service 118 may communicate with other software applications or services (e.g., the software applications 112, third party services 108, etc.) to provide information, data, commands, or other messages that cause the software applications or services to take some action. The task management service 118 may also monitor event records from the event services 110 (or directly from software applications or services) to identify when a task has been completed and remove or modify task items that correspond to that task. For example, in response to receiving an event record with respect to an issue at an issue tracking system (e.g., the issue tracking system 112-2), the task management service 118 may generate a task item for that task. When a user subsequently addresses the task (e.g., via a graphical user interface of the task management or by direct interaction with the issue tracking system), an event record may be generated by the event service 110. In response to receiving or accessing the event record relating to the completion or change in the issue, the task management service 118 may determine that the task has been completed or its status has changed and update any corresponding task items. Updating corresponding task items may include deleting the task item or removing the task item from a user's task list (e.g., if the event record indicates completion of the task), changing content of a task item (e.g., if the even record indicates a change in some aspect of the task or content item), changing a due date or duration of a task item, changing an urgency of a task item, changing a task category or task category rank of a task item, or the like. Thus, the task management service 118 may automatically update and maintain its task items based on operations that occur in the target applications and outside of the graphical user interface of the task management service 118.

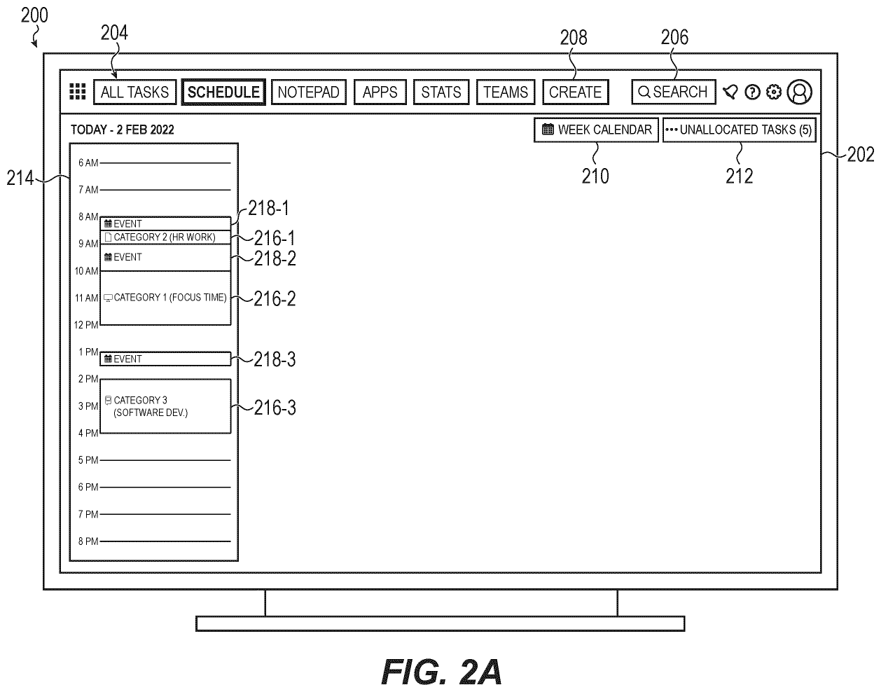

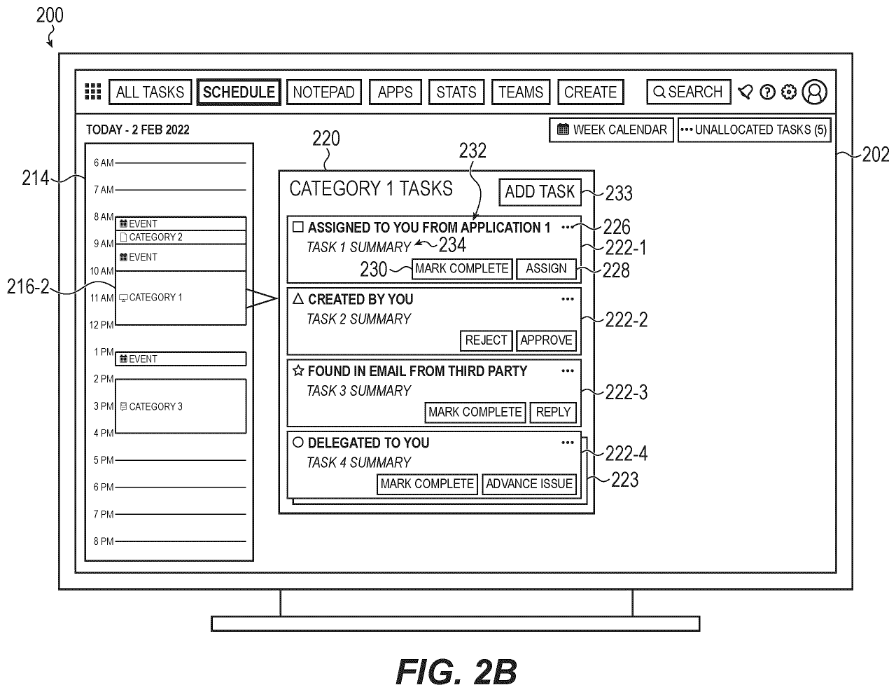

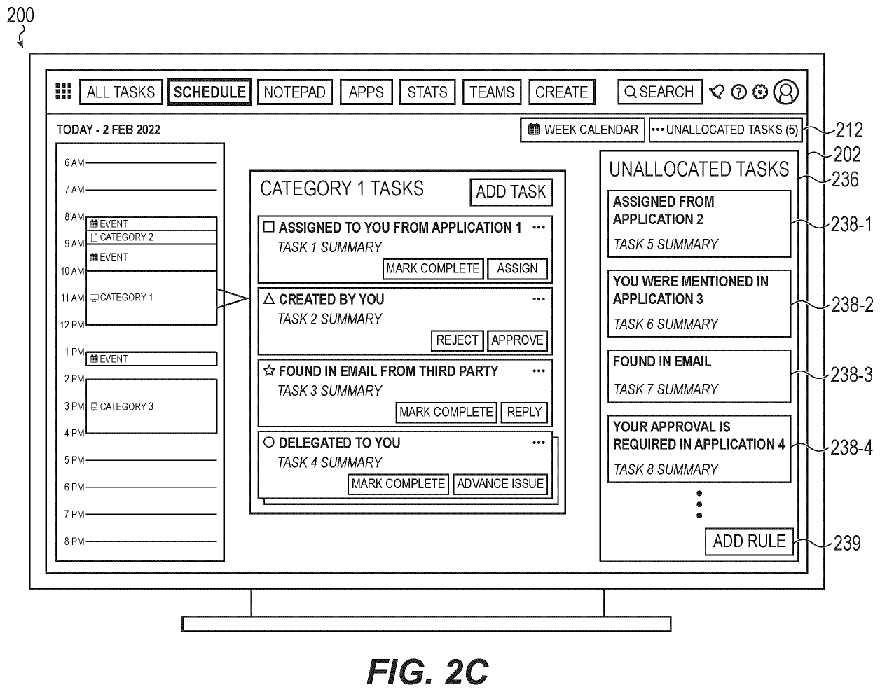

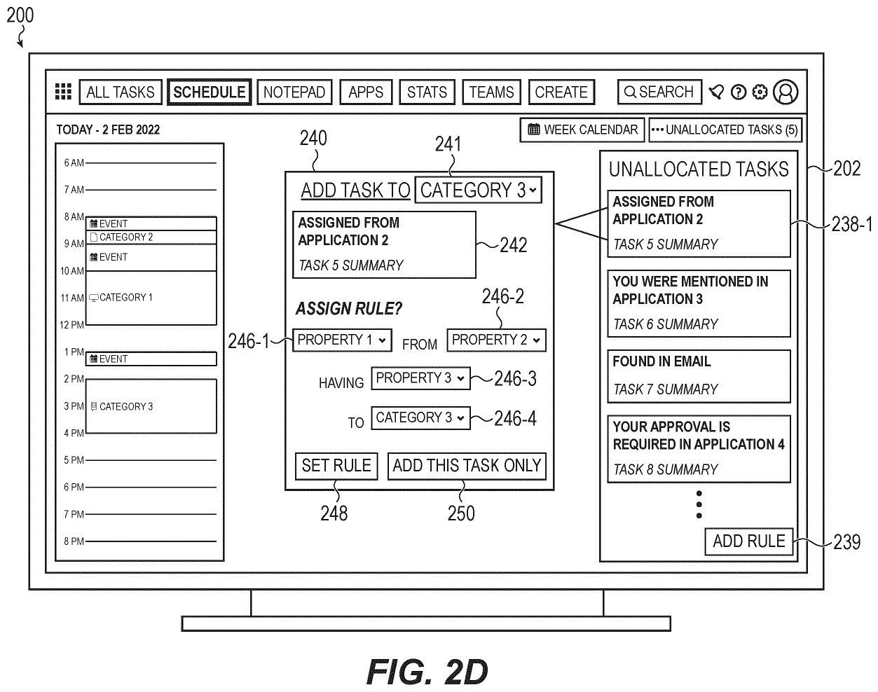

FIG. 2A illustrates a client device 200 (which may correspond to a client device 104 in FIG. 1A) displaying an example graphical user interface 202 associated with a task management service 118. The graphical user interface (GUI) 202 may be displayed on a client device 104. The GUI 202 may include menu items 204 for selecting various different modes, functions, operations, or services of the task management service 118 and/or the GUI 202. The GUI 202 may also include a search field 206 that allows a user to provide search queries to the task management service 118. The search queries may return search results, which may include task items, task categories, and the like.

The GUI 202 may also include a task item creation element 208. In response to a selection of the task item creation element 208, a user may be provided with user interface elements that allow the user to provide information about a task item to be created. For example, the user may supply a task title and/or summary, an application or service on which the task may be performed, a due date, a start date, a duration, and/or other information. The task management service 118 may generate a task item based on the information. The task management service 118 may also analyze the user-generated task item to select a task category for the user-generated task item, determine a task category rank for the task item, and incorporate the user-generated task item into a calendar or task list for the user. In some cases, a user may select a task category and/or a task category rank for the user-generated task item.

Users may create task items for other users as well. For example, when creating a task item, the creating user can specify one or more users to which the task item should be assigned. Upon detecting creation of a task item that is assigned to one or more users, the task management service 118 may incorporate those task items into the task lists of the target users.

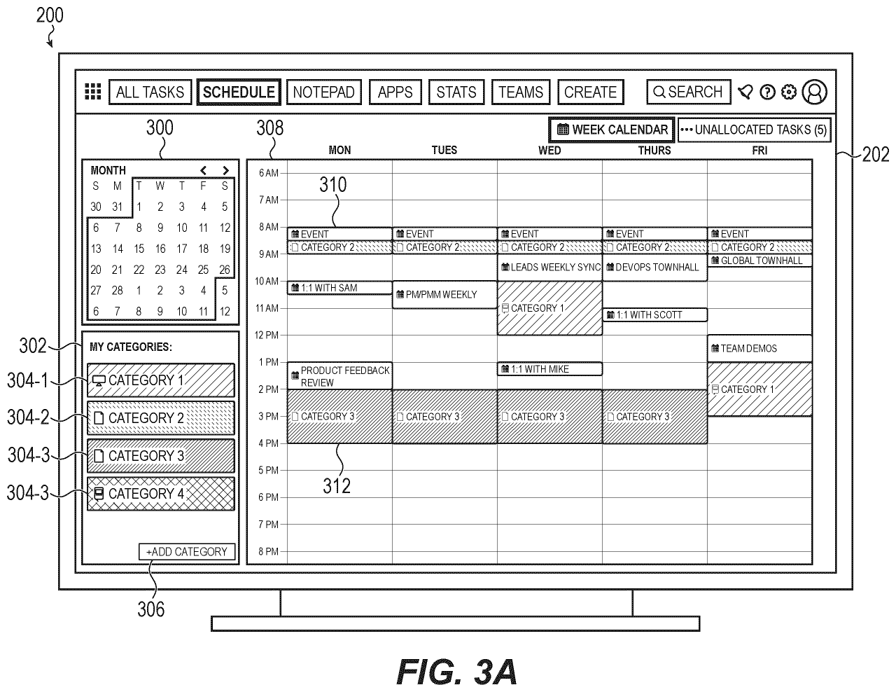

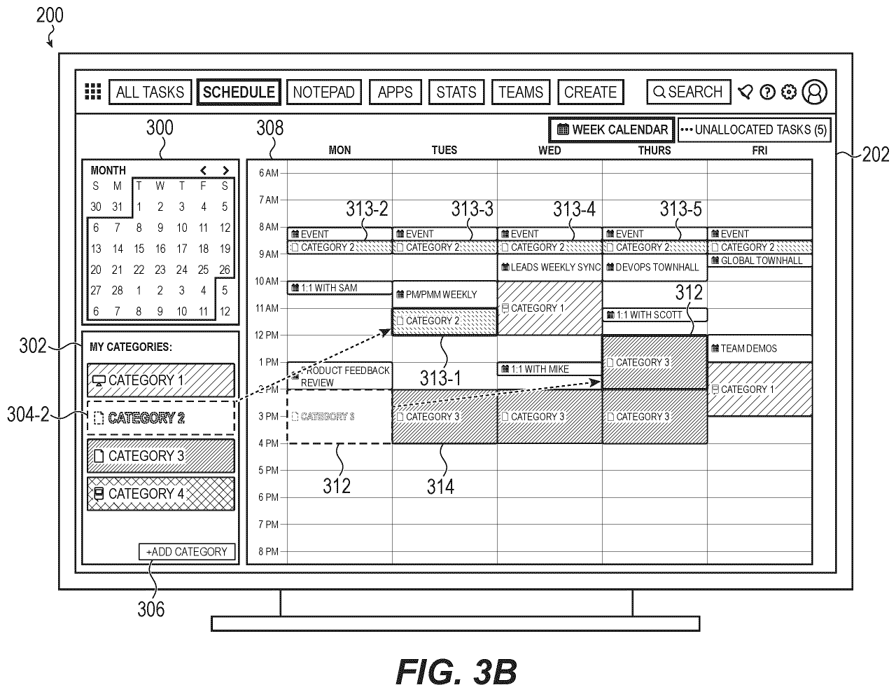

The GUI 202 also may also include view selection elements, such as a view selection element 210. The view selection elements allow a user to select a different manner in which the user's tasks and/or calendar is displayed in the GUI 202. For example, a user may select the view selection element 210 to cause the GUI 202 to display a week calendar view (as shown in FIG. 3A), as opposed to a daily view (as shown in FIG. 2A). Additional view selection elements may be shown, corresponding to different calendar or task item view styles.

The GUI 202 may also include an unallocated task item selection element 212. Selection of the selection element 212 may cause the GUI 202 to display a listing of unallocated task items (e.g., the selection element 212 may toggle the display of the listing). A user may manually allocate those task items to task categories and may create rules for categorizing similar task items that the task management service 118 will apply to future task items that it generates or otherwise receives.

The GUI 202 may also include a calendar object 214. The calendar object 214 may display calendar items at their assigned times. Calendar items may include events 218 (e.g., 218-1-218-3) and task category blocks 216 (e.g., 216-1-216-3). Events 218 may correspond to any event or scheduled item, including meetings, appointments, reminders, or the like, and may be generated by the user, generated by the task management service 118, supplied by external or third-party calendar systems, or the like. Events 218 may be assigned to or associated with a start time and a duration. Events 218 may represent allocated or reserved times on the calendar.

The task category blocks 216 may be user-allocated or automatically generated time blocks that are assigned to particular task categories. As shown, the task categories are identified by category 1, category 2, and category 3, though this is merely for illustration, and task categories may have titles that are indicative of the character of the tasks that are included in those categories. For example, task category blocks may have titles such as “HR (human resources),” “focus time,” “administrative,” “software development,” “management,” “supervisory,” or any other title that corresponds to a task category. As noted, task categories may be defined by a user, and the rules that determine how task items are categorized into those task categories may also be determined, modified, or otherwise managed by a user.

Task category blocks 216 may be assigned to particular time blocks by a user. Thus, for example, the user may specify the start time and duration for task category blocks. In some cases, task category blocks 216 are freely assignable, and any number of task category blocks may be scheduled for a given task category. Thus, a user can specify when and for how long each task category should be scheduled.

As described herein, task items are assigned to task categories by the task management service 118 (and/or by users). The GUI 202 allows users to view the task items in each task category, and more particularly, the task items that are allocated to a particular time block for that task category. FIG. 2B illustrates the GUI 202 with a task item object 220 displayed. The task item object 220 may be displayed for task category 1, such as in response to a user selection of the task category block 216-2.

The task item object 220 displays representations of the task items 222 that are allocated to that particular task category. For example, the task category 1 was selected for each of task items 222-1 through 222-4, and the task items 222-1 through 222-4 were allocated to the particular task category block 216-2 as described herein. Moreover, the task items 222 are displayed in accordance with the task category ranks that were determined for each task item 222. Thus, task item 222-1 has a higher task category rank than the other task items in that category and is displayed above the other task items. While task category ranks may be automatically determined by the task management service 118, a user may override and/or otherwise assign task category ranks to task items.

As described herein, the task management service 118 may determine that multiple event records correspond to a single task and may associate the tasks in certain ways in order to avoid duplicate or redundant task items. In some cases, the task management service 118 may not generate an additional task item when additional event records relating to that same task are found. In other cases, it may incorporate information from the additional event records into an already existing task item (e.g., to indicate that the task was also found in other sources, to indicate an urgency of the task item, etc.). In other cases, it may generate additional task items and associate those additional task items with the original task item for the task. FIG. 2B illustrates an example in which a representation of an additional task item 223 is shown in association with a primary task item 222-4. More particularly, the task management service 118 detected an additional event record that was indicative of the same task as the task item 222-4. Accordingly, the task management service 118 generated a secondary task item 223 and associated the secondary task item 223 with the primary task item 222-4. The task management service 118 may depict a representation of the secondary task item 223 in association with the representation of the primary task item 222-4, as shown in FIG. 1B. A secondary task item may have the same or similar appearance and content as a primary task item and may be interacted with in the same manner as a primary task item. Moreover, since the primary and secondary task items relate to a same task, a change in status of the underlying task or one of the task items (e.g., completion of the task, delegation of the task, deletion of a primary task item, etc.) will affect all associated task items for that task (e.g., the primary and any number of secondary task items).

Selection of a task item 222 in the task item object 220 may cause a GUI associated with a target application (e.g., a software application associated with the task, on which the task may be accomplished) to be displayed to a user. For example, the task item 222-1 may correspond to a task that is to be performed in an issue tracking system. Thus, selection of the task item 222-1 (or a selectable element in the task item 222) may cause a GUI of the issue tracking system (and optionally the exact issue to which the task item relates) to be displayed.

The displayed task items 222 in the task item object 220 may include various informational and selectable elements. For example, the task items 222 may include a task item source 232 (e.g., indicating the source application or service from which the task was identified), a task summary (e.g., task summary 234) that provides some information about the task item, and an expansion element 226. The expansion element 226, may, when selected, provide additional options or actions for the task items (e.g., to re-categorize task items, delete task items, re-rank task items, change or view rules that caused the task item to be categorized and/or ranked in a particular manner, etc.).

Task items may also include selectable elements (e.g., selectable element 228) that allow the user to effectuate some aspect of the task item directly via the task item object 220. Thus, the user can effectuate certain operations in a remote system (e.g., a software application of the application platform 102, a third party service 108, etc.) directly via the GUI 202, without having to leave the GUI 202 and interact with a separate application. The particular selectable elements that are included, and the operations are performed in response to their selection, may be based at least in part on properties of the task item itself (e.g., the target application, event source, a content type of an underlying content item, etc.).

For example, a task item (e.g., task item 222-1) may correspond to a task that is to be performed in an issue tracking system. As such, the selectable element 228 may be an option to assign an issue to a user. Upon selecting the selectable element 228, a task assignment object may be displayed to the user (e.g., within the GUI 202) in which the user can assign the task to another individual. Alternatively, selecting the selectable element 228 may cause a GUI of an issue tracking system to be displayed.

As another example, the task item 222-2 may relate to a task whereby a user is required to approve a change to a document or codebase. Accordingly, a selectable element (e.g., “Approve”) may be provided that, upon selection, causes the change to be approved. More particularly, upon selection of the element, the task management service 118 may cause information indicating the user's approval to be sent to the underlying application or service on which the change is to be approved (e.g., a codebase system, issue tracking system, content collaboration system, etc.).

As another example, the task item 222-3 may relate to a task of replying to an email or chat message. Accordingly, a selectable element (e.g., “Reply”) may be provided that, upon selection, causes a reply message to be initiated. A message reply object in which the user can provide the reply content may be displayed in the GUI 202, or a separate application may be initiated or displayed to facilitate the reply.

As yet another example, the task item 222-4 may correspond to a task that is to be performed in an issue tracking system, in which the user is required to advance an issue to a next state. Accordingly, a selectable element (e.g., “Advance Issue”) may be provided that, upon selection, causes the issue to be advanced.

The task items may also include a selectable element 230 that a user can select to mark a task item as complete. Upon being marked as complete, the task item may be marked as complete in the task management service and it may be removed from the user's task list.

Other types of selectable elements may include a “delegate” element that allows the user to delegate the task item to another user. In response to selecting the delegate element, one or more interface elements may be displayed (e.g., a user search function) to allow the user to identify another individual, department, or other entity to assign the task item to. Upon delegation, the task management service 118 may assign the task item to the other entity and may analyze the task item for that particular entity. For example, the task management service 118 may categorize the task item for that particular entity, based on how the character of the task corresponds to that entity's particular task categorization scheme and/or preferences. The task management service 118 may also rank the task item for that particular entity, and generally incorporate the task item into the new entity's task items in a manner that is specific to the new entity (which may be different than the manner in which it was incorporated into the original user's task items).

While the task items in the figures include various selectable elements, these are merely for illustration, and different selectable elements may be included in some or all task items. In some cases, the particular selectable elements that are included in a task item are unique to that task item. Thus, different task items may have different selectable elements. The particular selectable elements in a given task item may depend, for example, on the software application in which the associated task may be performed (e.g., the target application), the type of task associated with the task item, and the like. Moreover, upon selection of a selectable element (and based on the particular type of action associated with the selectable element) additional graphical objects, input fields, user interface elements, or the like, may be displayed in the GUI 202 to allow a user to provide details and/or commands.

As described above, some task items may not be assigned to task categories by the task management service 118, such as where a task categorization service 121 does not identify a task category for a task item with a sufficient confidence value. Accordingly, a user can allocate such tasks to categories via the GUI 202. For example, in response to a user selection of the unallocated task item selection element 212, the GUI 202 displays an unallocated task object 236, which includes a list of at least a subset of unallocated task items 238 that are associated with that user and which have not been allocated to a task category (e.g., task items 238-1-238-4). The unallocated task items 238 may include a task source and a task item summary, and/or other information.

The unallocated task object 236 may also include an add-rule element 239. Selection of the element 239 may cause the GUI 202 to display a rule definition interface in which users can define rules for how task items should be categorized.

FIG. 2D illustrates the GUI 202 displaying a task item assignment object 240 (or simply assignment object 240), which may be displayed in response to a user selection of an unallocated task. The assignment object 240 may provide a category assignment element 241 with which a user can assign the selected task item to a particular category. The category assignment element 241 may provide a list of candidate categories (e.g., a list of each task category associated with a particular user). In some cases, the category assignment element 241 provides a pre-populated suggestion of a task category for the unallocated task item. The pre-populated task category suggestion may be a task category, identified by the task categorization service 121, that had a highest confidence value. The user may select a task category using the category assignment element 241 and may add the task item to that category by selecting a confirmation 250 element. The confirmation element 250 may operate to assign only the selected unallocated task item (e.g., the task item 238-1) to the selected category.

The task item assignment object 240 may also include a rule assignment interface 244 that facilitates the creation of a rule for assigning task items to task categories. The rule assignment interface 244 may include task item property selectors, such as selectors 246-1-246-3, and a category selector 246-4. The task item property selectors may allow a user to specify properties of task items that will define what task items are assigned to a selected category. The task item property selectors may provide lists of pre-selected task item properties that may be used to define a rule. Example properties include, without limitation, a task source (e.g., an application or service from which a task was identified), a target application (e.g., an application or service on which a task may be completed), a content item type (e.g., whether the content item associated with the task is a document, page, issue, codebase, email, etc.), a content item status (e.g., a status of an issue to which the task relates), a due date, a start date, an identity of a task assignor or delegator (e.g., the individual or entity that assigned the task), and a project with which the task is associated. In some cases, any property or information about task items or their underlying content items that is stored by or accessible to the task management service 118 may be used to form the basis of a task categorization rule.

In some cases, task item properties and a proposed task category are preselected in the task item assignment object 240, based on the unallocated task item that was selected by a user. Thus, for example, the task categorization service 121 may identify a set of proposed salient task item properties for the selected unallocated task (e.g., a content item type, a source application, and a status), and a proposed task category (e.g., the task category identified by the task categorization service 121 as having the highest confidence value), and pre-populate the task assignment object 240 with those values. The user may then be able to quickly and easily determine whether the proposed rule is appropriate, make any desired changes to the rule definition, and can set the rule for the selected unallocated task item and for application by the task categorization service 121 to task items that it analyzes in the future (e.g., by selecting a “set rule” element 248). As noted above, the user may choose to forgo the setting of the rule, and instead only assign the selected unallocated task to a given task category.

The rule assignment interface 244 may also be presented by the GUI 202 in other ways and in response to other user selections. In some cases, the rule assignment interface 244 is provided separately from a task item assignment object 240 (e.g., not in conjunction with an interface for assigning an unallocated task to a task category). For example, the rule assignment interface 244 may be displayed response to a user selection of an “add rule” element 239 (which may be shown in conjunction with a list of unallocated tasks, or elsewhere in the GUI 202).

Once a task item is assigned to a task category (either automatically by the task categorization service 121 or manually by a user), the task management service 118 (e.g., using the calendar management service 122 or other suitable service) may determine a task category rank for the task item, and allocate the task items in a given task category among the user-specified time blocks associated with that task category.

FIGS. 3A-3B illustrate the GUI 202 displaying a calendar user interface of the task management service 118. The calendar user interface includes a calendar object 308, which may be any predefined or user-selected time range (e.g., a business week, a full week, a month, an arbitrary date range, etc.). The calendar object 308 may graphically represent time segments, such as one-hour segments, in which calendar entries may be organized and displayed. The calendar object 308 may include events 310 (e.g., general calendar entries relating to any meeting, event, reminder, appointment, etc. for a user) and user-specified task-category blocks (e.g., blocks of time that are assigned to specific task categories).

The calendar user interface may also include a monthly calendar element 300, which may indicate the month, week, day, or other time range currently illustrated in the calendar object 308. The monthly calendar element 300 may also allow a user to select a particular month, week, day, or other time range to be displayed in the calendar object 308 (e.g., by clicking on a date or range of dates, selecting a month navigation button, etc.).

The calendar user interface may also include a task category picker region 302. The task category picker region 302 may show elements 304 that correspond to the particular task categories of a user of the task management service 118 (e.g., the particular task categories shown in the picker region 302 are unique to each user). The task category picker region 302 may also include an “add category” element 306, which a user can select in order to create additional task categories. Rules for assigning task items to the new categories may be created as described herein (e.g., via a rule assignment interface 244).

As described herein, user-specified task-category blocks may be crated in a calendar for task categories. In particular, a user may create a user-specified task-category by assigning task categories to specific time blocks in a calendar user interface. For example, as shown in FIG. 3A, the calendar object 308 displays user-specified task-category blocks for task categories associated with the user. The user can select the start time and duration of each user-specified task-category block and may create any number of user-specified task-category blocks for the task categories. Based on the particular user-specified task-category blocks that are designated by a user, the task management service 118 (e.g., the calendar management service 122) may allocate the task items among the user-specified task-categories. For example, in response to a user creating a user-specified task-category block for a selected task category in a calendar object (e.g., the calendar object 308) of the GUI 202, the calendar management service 122 may assign respective task items of that task category to the user-specified task-category block. As described herein, all of the task items for a given category may be assigned to each of the time blocks associated with a task category, such that the user can easily see and manage all of the tasks associated with that task category.

In some cases, the calendar management service 122 may distribute the task items in a task category among the user-specified task-category blocks for that task category. For example, the task items may be distributed evenly among all of the user-specified task-category blocks for that task category, or it may distribute task items in proportion to the duration of each user-specified task-category block (e.g., one task item for each 15 minute increment, or other increment, in a user-specified task-category block), or the like. In such cases, when a user changes the number and/or duration of user-specified task-category blocks for a given task category, the calendar management service 122 may re-distribute the task items among the new set of user-specified task-category blocks. Additionally, when the task items in a task category are changed (e.g., new task items are added, task items are completed or moved, etc.), the calendar management service 122 may re-distribute the current task items among the existing user-specified task-category blocks.

The calendar object 308 of the GUI 202 may facilitate user creation and manipulation of user-specified task-category blocks. FIG. 3B illustrates various examples of user interactions with the calendar object 308, each of which may initiate a reallocation or reassignment of task items to the user-specified task-category blocks. For example, a user-specified task-category block may be created by dragging and dropping an identifier of a task category (e.g., element 304-2, representing task category 2) into a particular location on the calendar object 308. In response, the calendar management service 122 generates a user-specified task-category block 313 for that task category at that time. (The user may also be able to select or modify the duration of the user-specified task-category block, as well as any other property such as start time.) In examples where task items are allocated to specific user-specified task category blocks, creation of the user-specified task-category block 313 may cause the calendar management service 122 to reallocate the task items associated with that task category among the relevant user-specified task-category blocks (e.g., the user-specified task-category blocks 313-2-313-6). This may include removing task items from one or more user-specified task-category block and adding task items to the user-specified task-category block 313-1.

FIG. 3B also illustrates an example in which a user may drag and drop a pre-existing user-specified task-category block 312 from one location in the calendar object 308 to another location. This re-assignment of the user-specified task-category block 312 may also cause the calendar management service 122 to reallocate the task items associated with that task category among the relevant user-specified task-category blocks. For example, in optional use cases where the calendar management service 122 allocates different task items to different blocks, moving a task-category block may cause the calendar management service 122 to reallocate the task items in order to conform to the task category ranks of the task items. In particular, as the user-specified task-category block 312 is the first block for that particular task category, the task items having the highest task category ranks may have been allocated to that block. As a result of the user moving the block 312, it is no longer the first block for that task category. Accordingly, the calendar management service 122 may reallocate the task items such so that the highest-ranking task items are allocated to the user-specified task-category block 314 (and further reallocate the task items among the user-specified task-category blocks for that task category, as described herein).

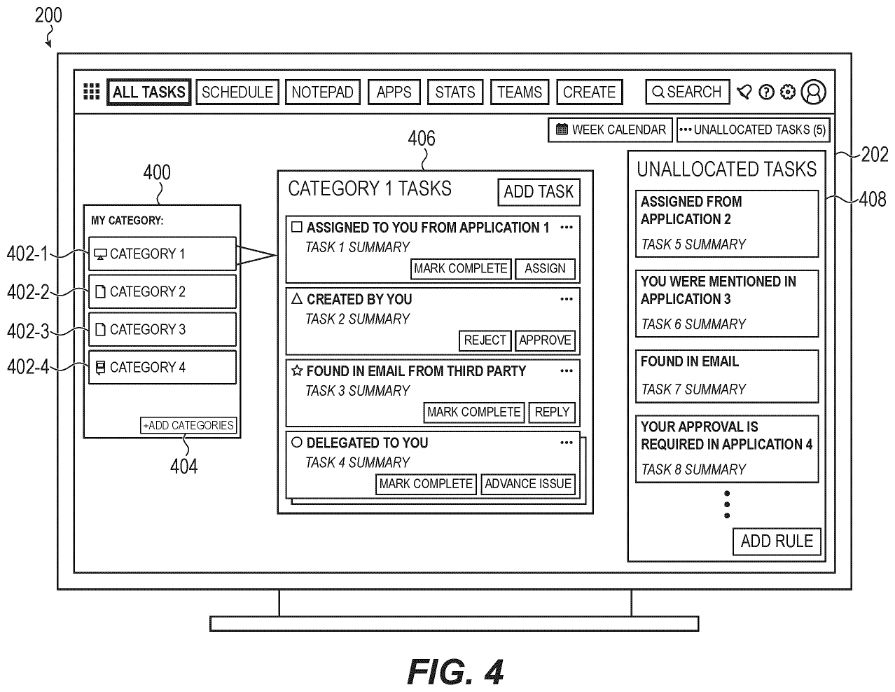

While the calendar object 308 easily and quickly illustrates a user's user-specified task-category blocks, it may not display the actual task items in a given task category. Accordingly, a user may select a user-specified task-category block in the calendar object 308, which may cause the GUI 202 to display a task item object, such as the task item object 220. In some cases, in response to a selection of a user-specified task-category block, the GUI 202 transitions from the calendar user interface shown in FIG. 3A-3B to a day view in which the task item object 220 is displayed for the selected user-specified task-category block, as shown in FIG. 2B. Alternatively, the GUI 202 may transition to a task item view, as shown in FIG. 4.

FIG. 4 illustrates a task item view user interface of the GUI 202. The task item view user interface may include a task category picker object 400, a task item object 406, and an unallocated task object 408. These objects may be selectively displayed or hidden, depending on user preferences and selection. The task category picker object 400 may include elements 402 that correspond to the task categories for the user, and optionally an “add category” element 404, which a user can select in order to create additional task categories. Rules for assigning task items to the new categories may be created as described herein (e.g., via a rule assignment interface 244). The unallocated task item object 408 may display unallocated task items and may operate as described above with respect to FIGS. 2C-2D.

In response to a user selection of a task category in the task category picker object 400 (e.g., the task category 402-1), the GUI 202 may display the task item object 406, and display, in the task item object 406, at least a subset of the task items associated with that task category. The task items may be displayed according to the task category ranks of the task items. If a task category has more task items than can be displayed in the task item object 406, the list may be scrollable or otherwise allow a user to cause other task items in the category to be displayed.

The task item object 406 may allow users to interact with task items, as described herein. For example, a user may delete task items, delegate task items, mark task items as “complete,” or the like. As another example, the task items may include objects or elements with which a user may interact in order to affect or change an underlying content item (e.g., changing a status of a content item, approving a change to a content item, adding a comment to a content item, etc.).

A user may also re-order task items in the task item object 406 in order to change their task category ranking. Upon receiving a user input changing a task category ranking (e.g., a user dragging and dropping a task item to a different location in the list of task items), the calendar management service 122 may reassign task category ranks to the task items, in accordance with the user-specified change. For example, if a user moves a task item from first to second in the listing, the calendar management service 122 may reassign task category rankings in a manner that ensures that the moved task item is displayed in the second position in the list.

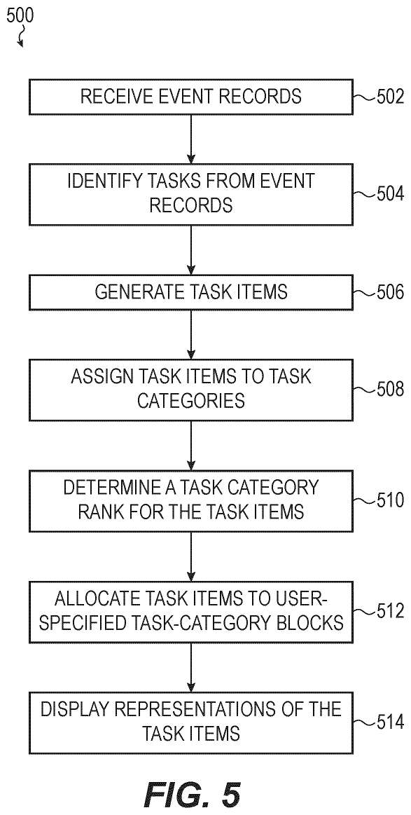

FIG. 5 is a flow chart of an example process 500 for generating task items and allocating task items among user-specified task-category blocks. The process 500 may be performed by devices and/or services of the system 100, including, for example, a task management service 118, an application platform 102 and associated event service 110, client devices 104, and third-party services 108.

At operation 502, a plurality of event records is received. The event records may be received from an event service, and each respective event record may be associated with a user and originating at an event source (e.g., a software application or service).

At operation 504, it is determined whether an event record of the plurality of event records corresponds to a task for the user. Determining whether an event record of the plurality of event records corresponds to a task may be performed by the task management service 118 using natural language processing techniques, trained models that output whether event records are likely to be associated with tasks, or the like.

At operation 506, a task item is generated for the identified task. The task item may be generated in accordance with a determination that the event record corresponds to a task for the user. Operation 506 may include extracting content from the event record (e.g., a title of a task, a summary of a task, an assignor or delegator of the task, a software application on which the task can be performed, etc.), generating a task item for the task, the task item including the extracted content, and storing the task item in association with the user.

If it is determined (e.g., at operation 504) that an event record corresponds to a task that is already the subject of a task item (e.g., a primary task item), a secondary task item may be generated for that task and associated with the primary task item (and optionally displayed in conjunction with one another). In other examples, data from the redundant event record may be added to the primary task item.

At operation 508, the task item may be assigned to a task category. Assigning the task item may include analyzing at least one of the task item or the event record to identify, independent of the event source, a software application associated with the task (e.g., a software application on which the task can be completed, such as an issue tracking system, a codebase system, a content collaboration system, etc.). Assigning the task item may also include selecting, based at least in part on the identified software application, a task category for the task item. The task category may be selected from a set of candidate task categories. The candidate task categories may be defined by a user, and may generally relate to a role, capacity, or function of the user, or any other commonalities that exist between tasks.

In some cases, assigning the task item may include providing the task item as input to a trained categorization model and assigning the task item to a selected task category based on output from the trained categorization model. The trained categorization model may be trained with training data generated from a set of respective sample task items each associated with a respective sample task category of a plurality of task categories and may be occasionally retrained based on historical data from a user (e.g., including manual assignments of task items to different task categories).

At operation 510, a task category rank is determined for the task item. The task category rank may define a ranking of the task item relative to other task items in the selected task category. The task category rank may be determined based on properties of the task item, the event record that corresponds to the task item, a content item to which the task item relates, or the like. Such properties may include a due date for the task, a start date for the task, an urgency of the task (e.g., as specified by the user or specified in the content item to which the event record and task item relate), an expected duration for the task (as specified by the user or determined based on historical data for the user for similar tasks), and the like.

At operation 512, the task item may be allocated to a user-specified task-category block of a set of user-specified task-category blocks associated with the selected task category. The allocation may be based at least in part on the task category rank of the task item. For example, a higher ranked task item may be allocated to an earlier user-specified task-category block in a user's calendar. In some cases, the task item may be allocated to a user-specified task-category block depending on the number of user-specified task-category blocks in the user's calendar for a particular task category, the number of task items in the task category, and the category rank of the task item.

In some cases, the allocation of task items among user-specified task-category blocks is updated in response to various events, including but not limited to the generation of new task items, the removal or completion of existing task items, and the addition, removal, or modification of user-specified task-category blocks in a calendar. In response to such events, the task items of a given task category are reallocated among the user-specified task-category blocks in accordance with the task category ranks.

At operation 514, a representation of the task item may be displayed in a task item object of a graphical user interface in accordance with the task category rank of the task item. For example, FIGS. 2B-2C and 4 illustrate task item objects in which representations of task items are displayed.

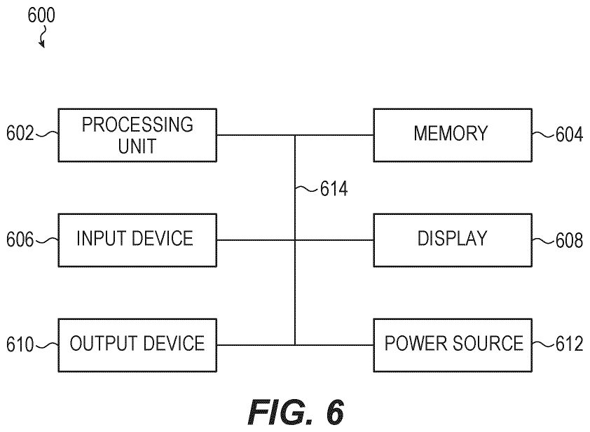

FIG. 6 illustrates a sample electrical block diagram of an electronic device 600 that may perform the operations described herein. The electronic device 600 may in some cases take the form of any of the electronic devices described with reference to FIGS. 1A-5, including client devices 104 and servers or other computing devices associated with or otherwise providing the services of the system 100, the application platform 102, third party content services 108, and task management service 118. The electronic device 600 can include one or more of a display 608, a processing unit 602, a power source 612, a memory 604 or storage device, input devices 606, and output devices 610. In some cases, various implementations of the electronic device 600 may lack some or all of these components and/or include additional or alternative components.

The processing unit 602 can control some or all of the operations of the electronic device 600. The processing unit 602 can communicate, either directly or indirectly, with some or all of the components of the electronic device 600. For example, a system bus or other communication mechanism 614 can provide communication between the processing unit 602, the power source 612, the memory 604, the input device(s) 606, and the output device(s) 610.

The processing unit 602 can be implemented as any electronic device capable of processing, receiving, or transmitting data or instructions. For example, the processing unit 602 can be a microprocessor, a central processing unit (CPU), an application-specific integrated circuit (ASIC), a digital signal processor (DSP), or combinations of such devices. As described herein, the term “processing unit” is meant to encompass a single processor or processing unit, multiple processors, multiple processing units, or other suitably configured computing element or elements.

It should be noted that the components of the electronic device 600 can be controlled by multiple processing units. For example, select components of the electronic device 600 (e.g., an input device 606) may be controlled by a first processing unit and other components of the electronic device 600 (e.g., the display 608) may be controlled by a second processing unit, where the first and second processing units may or may not be in communication with each other.

The power source 612 can be implemented with any device capable of providing energy to the electronic device 600. For example, the power source 612 may be one or more batteries or rechargeable batteries. Additionally or alternatively, the power source 612 can be a power connector or power cord that connects the electronic device 600 to another power source, such as a wall outlet.

The memory 604 can store electronic data that can be used by the electronic device 600. For example, the memory 604 can store electronic data or content such as, for example, audio and video files, documents and applications, device settings and user preferences, timing signals, control signals, and data structures or databases. The memory 604 can be configured as any type of memory. By way of example only, the memory 604 can be implemented as random access memory, read-only memory, Flash memory, removable memory, other types of storage elements, or combinations of such devices.

In various embodiments, the display 608 provides a graphical output, for example associated with an operating system, user interface, and/or applications of the electronic device 600 (e.g., a graphical user interface associated with a collaborative document system, which may include graphical elements related to delivering document template recommendations, displaying documents, displaying document templates from which documents may be generated, displaying a workspace and/or document hierarchy, etc.). In one embodiment, the display 608 includes one or more sensors and is configured as a touch-sensitive (e.g., single-touch, multi-touch) and/or force-sensitive display to receive inputs from a user. For example, the display 608 may be integrated with a touch sensor (e.g., a capacitive touch sensor) and/or a force sensor to provide a touch- and/or force-sensitive display. The display 608 is operably coupled to the processing unit 602 of the electronic device 600.

The display 608 can be implemented with any suitable technology, including, but not limited to liquid crystal display (LCD) technology, light emitting diode (LED) technology, organic light-emitting display (OLED) technology, organic electroluminescence (OEL) technology, or another type of display technology. In some cases, the display 608 is positioned beneath and viewable through a cover that forms at least a portion of an enclosure of the electronic device 600.

In various embodiments, the input devices 606 may include any suitable components for detecting inputs. Examples of input devices 606 include light sensors, temperature sensors, audio sensors (e.g., microphones), optical or visual sensors (e.g., cameras, visible light sensors, or invisible light sensors), proximity sensors, touch sensors, force sensors, mechanical devices (e.g., crowns, switches, buttons, or keys), vibration sensors, orientation sensors, motion sensors (e.g., accelerometers or velocity sensors), location sensors (e.g., global positioning system (GPS) devices), thermal sensors, communication devices (e.g., wired or wireless communication devices), resistive sensors, magnetic sensors, electroactive polymers (EAPs), strain gauges, electrodes, and so on, or some combination thereof. Each input device 606 may be configured to detect one or more particular types of input and provide a signal (e.g., an input signal) corresponding to the detected input. The signal may be provided, for example, to the processing unit 602.

As discussed above, in some cases, the input device(s) 606 include a touch sensor (e.g., a capacitive touch sensor) integrated with the display 608 to provide a touch-sensitive display. Similarly, in some cases, the input device(s) 606 include a force sensor (e.g., a capacitive force sensor) integrated with the display 608 to provide a force-sensitive display.

The output devices 610 may include any suitable components for providing outputs. Examples of output devices 610 include light emitters, audio output devices (e.g., speakers), visual output devices (e.g., lights or displays), tactile output devices (e.g., haptic output devices), communication devices (e.g., wired or wireless communication devices), and so on, or some combination thereof. Each output device 610 may be configured to receive one or more signals (e.g., an output signal provided by the processing unit 602) and provide an output corresponding to the signal.

In some cases, input devices 606 and output devices 610 are implemented together as a single device. For example, an input/output device or port can transmit electronic signals via a communications network, such as a wireless and/or wired network connection. Examples of wireless and wired network connections include, but are not limited to, cellular, Wi-Fi, Bluetooth, IR, and Ethernet connections.

The processing unit 602 may be operably coupled to the input devices 606 and the output devices 610. The processing unit 602 may be adapted to exchange signals with the input devices 606 and the output devices 610. For example, the processing unit 602 may receive an input signal from an input device 606 that corresponds to an input detected by the input device 606. The processing unit 602 may interpret the received input signal to determine whether to provide and/or change one or more outputs in response to the input signal. The processing unit 602 may then send an output signal to one or more of the output devices 610, to provide and/or change outputs as appropriate.

Unless otherwise stated, the terms “include” and “comprise” (and variations thereof such as “including,” “includes,” “comprising,” “comprises,” “comprised” and the like) are used inclusively and do not exclude further features, components, integers, steps, or elements.

It will be understood that the embodiments disclosed and defined in this specification extend to alternative combinations of two or more of the individual features mentioned in or evident from the text or drawings. All of these different combinations constitute alternative embodiments of the present disclosure.

The present specification describes various embodiments with reference to numerous specific details that may vary from implementation to implementation. No limitation, element, property, feature, advantage or attribute that is not expressly recited in a claim should be considered as a required or essential feature. Accordingly, the specification and drawings are to be regarded in an illustrative rather than a restrictive sense.

What is claimed is:

1. A method comprising:
receiving a plurality of event records from an event service, each respective event record associated with a user and originating at an event source;
determining whether an event record of the plurality of event records corresponds to a task for the user;
in accordance with a determination that the event record corresponds to a task for the user:
extracting content from the event record;
generating a task item for the task, the task item including the extracted content; and
storing the task item in association with the user;
analyzing at least one of the task item or the event record to identify, independent of the event source, a software application associated with the task;
selecting, based at least in part on the identified software application, a task category for the task item, the task category selected from a set of candidate task categories;
determining a task category rank for the task item, the task category rank defining a ranking of the task item relative to other task items in the selected task category;
allocating the task item to a user-specified task-category block of a set of user-specified task-category blocks associated with the selected task category, the allocation based at least in part on the task category rank of the task item; and
displaying a representation of the task item in a task item object of a graphical user interface in accordance with the task category rank of the task item.

2. The method of claim 1, wherein:
the event record is a first event record;
the task is a first task;
the task item is a first task item;
the content is first content; and
the method further comprises:
in accordance with a determination that a second event record corresponds to a second task that is different than the first task, generating and storing a second task item for the second task; and
in accordance with a determination that the second event record corresponds to the first task:
extracting second content from the second event record;
generating a third task item for the first task, the third task item including the extracted second content;
storing the third task item in association with the user; and
causing a representation of the third task item to be displayed in the task item object in association with the first task item.

3. The method of claim 2, further comprising, in response to receiving an indication of completion of the first task item, removing the representations of the first task item and the second task item from the task item object.

4. The method of claim 1, wherein:
the event record is a first event record;
the content is first content; and
the method further comprises, in accordance with a determination that a second event record corresponds to a same task as the first event record:
extracting second content from the second event record;
storing the extracted second content in the task item; and
causing the extracted second content to be displayed in the task item object in the representation of the task item.

5. The method of claim 1 wherein:
a plurality of task items are associated with the selected task category, each respective task item in the plurality of task items associated with a respective task category rank; and
the method further comprises:
in response to a user creating the user-specified task-category block for the selected task category in a calendar object of the graphical user interface, assigning respective task items of at least a subset of the plurality of task items to the user-specified task-category block; and
displaying the assigned subset of the plurality of task items in the task item object in accordance with their respective task category ranks.

6. The method of claim 5, wherein:
the user-specified task-category block is a first user-specified task-category block;
the subset of the plurality of task items is a first subset of the plurality of task items; and
the method further comprises:
in response to a user creating a second user-specified task-category block for the selected task category in a calendar object of the graphical user interface, assigning respective task items of at least a second subset of the plurality of task items to the second user-specified task-category block; and
displaying the assigned second subset of the plurality of task items in the task item object in accordance with their respective task category ranks.

7. The method of claim 1, wherein:
the task is a first task;
the first task corresponds to a first operation for an issue of an issue tracking system;
the event record is a first event record;
the task item is a first task item;
the task category is a first task category; and
the method further comprises, in accordance with a determination that a second event record corresponds to a second operation for the same issue as the first task, the second operation different from the first operation:
generating a second task item for the second operation; and
selecting, based at least in part on the second operation, a second task category for the second task item, the second task category different from the first task category.

8. A method comprising:
receiving a plurality of event records from an event service, each respective event record associated with a user and originating at an event source;
determining whether an event record of the plurality of event records corresponds to a task for the user;
in accordance with a determination that the event record corresponds to a task for the user:
extracting content from the event record;
generating a task item for the task, the task item including the extracted content; and
storing the task item in association with the user;
providing the task item as input to a trained categorization model, the trained categorization model trained with training data generated from a set of respective sample task items each associated with a respective sample task category of a plurality of task categories;
assigning the task item to a selected task category based on output from the trained categorization model;
determining a task category rank for the task item, the task category rank defining a ranking of the task item relative to other task items in the selected task category;
allocating the task item to a user-specified task-category block of a set of user-specified task-category blocks associated with the selected task category, the allocation based at least in part on the task category rank of the task item; and
displaying a representation of the task item in a task item object of a graphical user interface in accordance with the task category rank of the task item.

9. The method of claim 8, wherein:
the event record is a first event record;
the task is a first task;
the task item is a first task item; and
the method further comprises:
generating and storing a second task item for a second task different from the first task;
in response to an assignment input from the user, associating the second task item with a second task category; and
retraining the trained categorization model using updated training data that includes the second task item associated with the second task category.

10. The method of claim 9, wherein the task is performable, by the user, on a software application that is different from the event source.

11. The method of claim 10, wherein the software application is an issue tracking system.

12. The method of claim 8, wherein:
the event record is a first event record;
the task is a first task;
the task category is a first task category;
the task item is a first task item; and
the method further comprises:
in accordance with a determination that a second event record different from the first event record corresponds to a second task for the user, generating and storing a second task item for the second task;
providing the second task item as input to the trained categorization model; and
assigning the second task item to a second task category based on output from the trained categorization model, the second task category different from the first task category.

13. The method of claim 12, wherein the first event record and the second event relate to different tasks for a same content item.

14. The method of claim 8, wherein:
a plurality of task items are associated with the selected task category, each respective task item in the plurality of task items associated with a respective task category rank; and
the method further comprises:
in response to a user creating the user-specified task-category block for the selected task category in a calendar object of the graphical user interface, assigning respective task items of at least a subset of the plurality of task items to the user-specified task-category block; and
displaying the assigned subset of the plurality of task items in accordance with their respective task category ranks.

15. The method of claim 8, wherein the user-specified task-category block includes a user-defined start time and a user-defined duration.

16. The method of claim 8, wherein:
the user-specified task-category block is a first user-specified task-category block and includes a first user-defined start time and a first user-defined duration; and
the set of user-specified task-category blocks comprises a second user-specified task-category block, the second user-specified task-category block including a second user-defined start time different from the first user-defined start time and a second user-defined duration different from the first user-defined duration.

17. A computer system comprising:
at least one processor; and
at least one memory storing instructions, which when executed by the at least one processor, cause the at least one processor to perform operations comprising:
receiving a plurality of event records from an event service, each respective event record associated with a user and originating at an event source;
determining whether an event record of the plurality of event records corresponds to a task for the user;
in accordance with a determination that the event record corresponds to a task for the user:
extracting content from the event record;
generating a task item for the task, the task item including the extracted content; and
storing the task item in association with the user;
analyzing at least one of the task item or the event record to identify, independent of the event source, a software application associated with the task;
selecting, based at least in part on the identified software application, a task category for the task item, the task category selected from a set of candidate task categories;
determining a task category rank for the task item, the task category rank defining a ranking of the task item relative to other task items in the selected task category;
allocating the task item to a user-specified task-category block of a set of user-specified task-category blocks associated with the selected task category, the allocation based at least in part on the task category rank of the task item; and
displaying a representation of the task item in a task item object of a graphical user interface in accordance with the task category rank of the task item.

18. The computer system of claim 17, wherein:
the task item is a first task item; and
the instructions further include instructions that cause the at least one processor to perform operations comprising:
providing a second task item as input to a trained categorization model, the trained categorization model trained with training data generated from a set of respective sample task items each associated with a respective sample task category of a plurality of task categories; and
assigning the second task item to a second selected task category based on output from the trained categorization model.

19. The computer system of claim 17 wherein:
a plurality of task items are associated with the selected task category, each respective task item in the plurality of task items associated with a respective task category rank; and
the instructions further include instructions that cause the at least one processor to perform operations comprising:
in response to a user creating the user-specified task-category block for the selected task category in a calendar object of the graphical user interface, assigning respective task items of at least a subset of the plurality of task items to the user-specified task-category block; and
displaying the assigned subset of the plurality of task items in the task item object in accordance with their respective task category ranks.

20. The computer system of claim 19, wherein:
the user-specified task-category block is a first user-specified task-category block;
the subset of the plurality of task items is a first subset of the plurality of task items; and
the instructions further include instructions that cause the at least one processor to perform operations comprising:
in response to a user creating a second user-specified task-category block for the selected task category in a calendar object of the graphical user interface, assigning respective task items of at least a second subset of the plurality of task items to the second user-specified task-category block; and
displaying the assigned second subset of the plurality of task items in the task item object in accordance with their respective task category ranks.
